(19) United States
(12) Patent Application Publication
(10) Pub. No.: US 2026/0193841 A1
(43) Pub. Date: Jul. 9, 2026

(54) A METHOD FOR MANUFACTURING A SHEET OF A FIBROUS MATERIAL

(71) Applicant: Inter IKEA Systems B.V., Delft (NL)

(72) Inventors: Dan PETTERSSON, Ljungby (SE); Mathias LARSSON, Varberg (SE)

(73) Assignee: Inter IKEA Systems B.V., Delft (NL)

(21) Appl. No.: 19/131,830

(22) PCT Filed: Nov. 21, 2023
(86) PCT No.: PCT/SE2023/051172

§ 371 Date: May 21, 2025

(30) Foreign Application Priority Data
Nov. 21, 2022 (SE) 2251358-4

(51) Int. Cl. D21F 1/00; D21F 7/06; D21H 11/14

(52) U.S. Cl. CPC D21F 1/0018; D21F 7/06; D21H 11/14

(57) ABSTRACT

A method for manufacturing a sheet of fibrous material. may involve providing fibrous material, milling the material, pre-dispersing the milled material in a first air flow inside a preparation tank using a first set of agitators arranged in the preparation tank, transporting the first air flow containing the pre-dispersed milled material in a duct from the preparation tank to a formation tank by a feeding fan, dispersing the pre-dispersed milled material in a second air flow inside the formation tank using a second set of agitators arranged in the formation tank, conveying the dispersed milled material by the second air flow, from the formation tank to a moving air-permeable belt, by creating a pressure drop over the belt drawing the second air flow through the belt, thereby depositing milled material on the belt and forming a mat of the milled material on the belt and compressing the mat to form the sheet.

### TECHNICAL FIELD

The invention relates to a method for manufacturing a sheet of a fibrous material, and a sheet manufacturing machine.

### BACKGROUND

Paper board, sometimes referred to as grey paper board, is often used in applications where a somewhat thicker paper is needed. Examples of use of paper board include the back of spiral paper blocks, smaller storage boxes, etc. The paper board is often based on recycled cardboard (sometimes referred to as OCC=Old Corrugated Cardboard) and other types of recycled paper. The recycled cardboard material is shredded in a shredder and then mixed with water to form a paper slurry. The paper pulp of the paper slurry is then formed on a paper wire and dried with steam and/or hot air in accordance with principles similar to those of any paper machine.

The energy consumption of such a paper making process is however relatively high, since the water used to form the paper slurry has to be removed by evaporation during the process in order to obtain the final dry paper product.

### SUMMARY

An objective of the invention is to provide a method for manufacturing a sheet of a fibrous material, which method has a relatively low energy requirement.

The objective is achieved by a method for manufacturing a sheet of fibrous material, wherein the method comprises the steps of providing fibrous material, milling the material to form a milled material, pre-dispersing the milled material in a first air flow inside a preparation tank by means of a first set of agitators arranged in the preparation tank, transporting the first air flow containing the pre-dispersed milled material in a duct from the preparation tank to a formation tank by a feeding fan, dispersing the pre-dispersed milled material in a second air flow inside the formation tank by means of a second set of agitators arranged in the formation tank, conveying the dispersed milled material by the second air flow, from the formation tank to a moving air-permeable belt, by creating a pressure drop over the belt drawing the second air flow through the belt, thereby depositing milled material on the belt and forming a mat of the milled material on the belt, and compressing the mat to form the sheet.

The invention is based on the insight that by such a method, the use of water can be heavily reduced or almost eliminated, and thereby the energy consumption and cost of evaporating water can be considerably reduced. Hereby, the sheet can be manufactured in a cost-efficient way without the use of a machine having an advanced and energy-intensive dryer section.

In contrast to a wet-type method starting with a slurry of shredded fibrous material mixed with water, the milled material, from entering the preparation tank to leaving the compression step, preferably has an absolute moisture content of less than 30% by weight, more preferably less than 25% by weight.

Before entering the preparation tank, the fibrous material can be milled in a dry state, such that for at least 50% by weight of the milled material, the fibres of the milled material have a fiber length in the range 0.2-5 mm and/or at least 50% by weight of the milled material has a particle size less than 10 mm.

Only a minor amount of water may be required, such as for improving inter-fiber bonding properties of the fibrous material or for dissolving and/or diluting a binder or any other substance to be added to the milled material. For example, water in an amount of 0.1-20% by weight of the milled material can be added to the milled material, optionally together with a binder, before the milled material is deposited on the belt.

Further, before and/or during the compressing of the mat formed by the milled material on the belt, optionally, water can be added to the mat, preferably by spraying water on an upper side and/or underside of the mat for improving thermal conductivity into the material during the compressing of the mat to form the desired sheet.

The mat of the milled material deposited on the belt can be formed with a thickness in the range of 5 -15 cm (i.e. 50 -150 mm), and preferably the mat is then pre-compressed to a thickness in the range 0.5-3 cm (i.e. 5-30 mm), and thereafter further compressed to form the sheet having a thickness in the range 0.5-5 mm, preferably 0.75-3 mm. For example, the mat can be compressed in a heat press device providing a temperature in the range 110-240° C. and a pressure in the range 10-75 bar to form the sheet.

By the method various fibrous materials can be used for manufacturing different types of sheets. For example, recycled paper material can be used, particularly for manufacturing paper board. The recycled paper material can be cardboard paper, office paper, newspaper or similar. From recycled paper material, preferably at least 50% by weight recycled paper material, paper board with a thickness in the range 0.5-3 mm and a surface weight in the range 500-3000 g/m² can, as an example, be produced.

According to one embodiment, the first set of agitators used in the method comprises a plurality of mechanical agitators, preferably a plurality of rotating rollers provided with protrusions on their respective surfaces, such as doffing rollers, wherein the mechanical agitators of the first set of agitators preferably rotate at a speed in the range of 500-5000 rpm. For example, the protrusions can have a length in the range 5-40 mm. Hereby, the milled material can be effectively disintegrated into particles and pre-dispersed in the first air flow.

According to a further embodiment, the second set of agitators used in the method comprises a plurality of mechanical agitators, preferably a plurality of rotating rollers provided with protrusions on their respective surfaces, such as spiked rollers, wherein the mechanical agitators of the second set of agitators preferably rotate at a speed in the range 500-5000 rpm. For example, the protrusions can have a length in the range 50 -150 mm. Hereby, the pre-dispersed milled material can be further disintegrated into particles and dispersed in the second air flow enabling, in the next step, the material to be evenly deposited on the belt at a controlled rate and with an even distribution across the width of the belt.

According to a further embodiment, the method comprises the step of adding a binder and/or water to the milled material, preferably adding the binder and/or water to the milled material in the preparation tank by injecting, such as spraying, the binder and/or water into the preparation tank via one or more injection nozzles. The binder and/or water will increase the strength of the sheet due to improved inter-fiber bonding properties. The binder can be pulverized starch, urea formaldehyde resins, MDI resins or other types of binders, including biobased binders and binders used in paper industry. By adding the binder and/or water after the milling of the material, clogging of material in the milling unit or in any other device in previous steps of the process is counteracted.

According to a further embodiment, the method comprises the step of adding the binder and/or water to the milled material by injecting the binder and/or water into the first air flow containing the pre-dispersed milled material. Hereby, the particles of the milled material pre-dispersed in the first air flow can be prepared to bond more strongly to each other when being deposited on the belt and forming the mat to be compressed to the sheet. Further, by injecting the binder and/or water into the first air flow containing the pre-dispersed milled material, the binder and/or water can be evenly distributed to the milled material in a rational way.

According to a further embodiment, the first set of agitators used in the method forms a separating partition between a receiving section of the preparation tank to which milled material is fed and a pre-dispersion section of the preparation tank in which the milled material is pre-dispersed in the first air flow, wherein the milled material is forced to pass via the separating partition formed by the first set of agitators to be pre-dispersed in the first air flow. Hereby, the first set of agitators can be arranged to move the milled material from the receiving section to the pre-dispersion section, and to throw the milled material into the first air flow. When using rotating rollers, such as doffing rollers, the milled material can leave the rollers with a speed corresponding to the rotation speed of the rollers when being thrown into the first air flow.

Further, an outlet of the pre-dispersion section connected to the duct can be arranged in a way securing that substantially only pre-dispersed milled material from the pre-dispersion section is transported with the first air flow from the preparation tank to the formation tank whereas the milled material in the receiving section remains until being pre-dispersed in the pre-dispersion section.

According to a further embodiment, the method comprises transporting the milled material entering the preparation tank towards the first set of agitators by a conveyor arranged in the preparation tank. Hereby, the requisite amount of milled material to be pre-dispersed by the agitators can reach the first set of agitators at the desired rate.

According to a further embodiment, the formation tank used in the method has an upper space and a lower space, wherein the height and volume of the upper space are within 30-250% of the height and volume, respectively, of the lower space, and wherein the upper space is substantially free of internal structures and the second set of agitators is arranged in the lower space, and preferably the upper space is arranged above an inlet via which the first air flow containing the pre-dispersed milled material enters the formation tank, and the lower space is arranged below the inlet. Hereby, an even distribution of particles in the airflow is promoted.

According to a further embodiment, the method comprises blowing the first air flow containing the pre-dispersed milled material into the formation tank in a substantially horizontal direction. Hereby, the distribution of particles in the formation tank can be further improved.

According to a further embodiment, the method comprises blowing the first air flow containing the pre-dispersed milled material into the formation tank through an elongated opening of the formation tank, wherein the opening is arranged with a major extent in a horizontal direction and a minor extent in a vertical direction, and preferably the elongated opening is arranged in a side wall of the formation tank, preferably a substantially vertical side wall. Hereby, an even distribution of particles in the airflow is promoted, which is particularly favourable when the width of the mat to be formed on the belt is relatively great.

According to a further embodiment, the method comprises adjusting an initial thickness of the mat by a rotating brush arranged above the belt at a location where the mat of the milled material formed on the belt leaves the formation tank, and preferably sealing an interior of the formation tank against ambient air by the rotating brush. Hereby, the mat can be formed on the belt without any disturbing air leaking into the formation tank which otherwise could have a negative impact on the second air flow and the distribution of milled material on the belt.

According to another aspect of the invention, a further objective is to provide a sheet manufacturing machine, which machine has a relatively low energy requirement.

This objective is achieved by a machine comprising a milling unit for milling fibrous material, a preparation tank having a first set of agitators for pre-dispersing the milled material in a first air flow inside the preparation tank, a formation tank having a second set of agitators for dispersing the pre-dispersed milled material in a second air flow inside the formation tank, a duct connecting the preparation tank and the formation tank, and a feeding fan for transporting the first air flow containing the pre-dispersed milled material in the duct from the preparation tank to the formation tank, a movable air-permeable belt and a vacuum unit for conveying the dispersed milled material by the second air flow, from the formation tank to the belt while the belt is moving, by creating a pressure drop over the belt drawing the second air flow through the belt, thereby depositing milled material on the belt and forming a mat of the milled material on the belt, and a compressing unit for compressing the mat to form the sheet.

The advantages of the sheet manufacturing machine are substantially the same as the advantages already discussed hereinabove with reference to the different embodiments of the method for manufacturing a sheet.

Further advantages and advantageous features of the invention are disclosed in the following description and in the claims.

### BRIEF DESCRIPTION OF THE DRAWINGS

With reference to the appended drawings, below follows a more detailed description of embodiments of the invention cited as examples.

In the drawings:

FIG. 1 is a schematic view of a sheet manufacturing machine, and

FIG. 2 is a view of a part of the sheet manufacturing machine illustrated in FIG. 1.

### DETAILED DESCRIPTION OF EXAMPLE EMBODIMENTS

Although the machine and the method described herein could be used for other fibrous material, manufacturing of a sheet of paper from recycled paper material will be described as an example only.

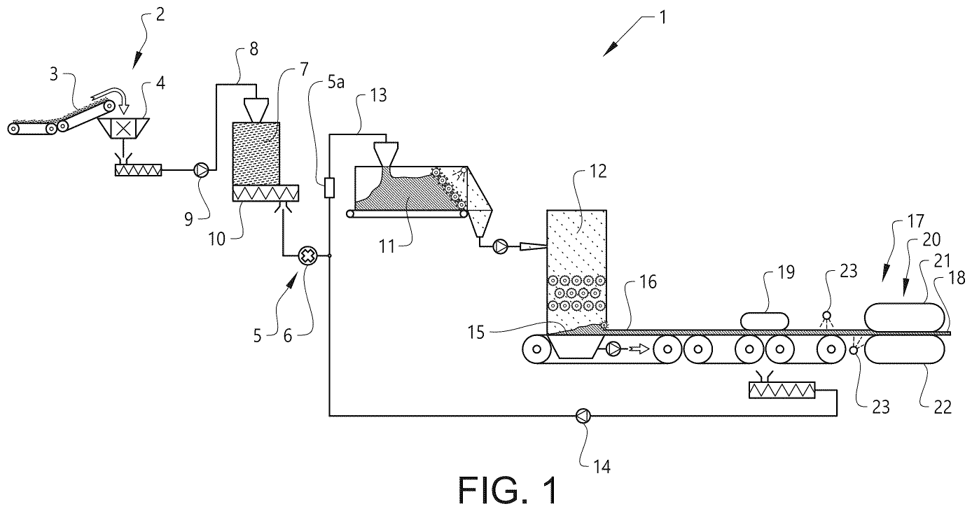

FIG. 1 is a schematic view of a sheet manufacturing machine 1. The machine 1 can be used for manufacturing paper board from paper material, preferably recycled paper material.

As illustrated in FIG. 1, the machine suitably comprises a cutting unit 2 for cutting fibrous material 3 into smaller pieces. The fibrous material 3 provided and fed to the cutting unit 2 can be recycled corrugated cardboard or other paper material. The cutting unit 2 can comprise a shredder 4. In the shredder 4, the paper material 3 is shredded into flakes, preferably with a size in the range 20-50 mm.

The machine further comprises a milling unit 5, such as a hammer mill 6, which mills or grinds the flakes into fluffy pulp of paper fibres. For at least 50% by weight of the milled material, the fiber length of the milled material leaving the milling unit 5 is preferably in the range 0.2-5 mm and/or the milled material has a particle size less than 10 mm.

In the example embodiment shown in FIG. 1, the machine 1 has a storage bunker 7 arranged between the cutting unit 2 and the milling unit 5. The flakes can be transported from the cutting unit 2 to the storage bunker 7 in a conduit 8 by a fan 9. The storage bunker 7 is suitably provided with a screw conveyor 10 for further transport of the flakes from the storage bunker 7 to the milling unit 5.

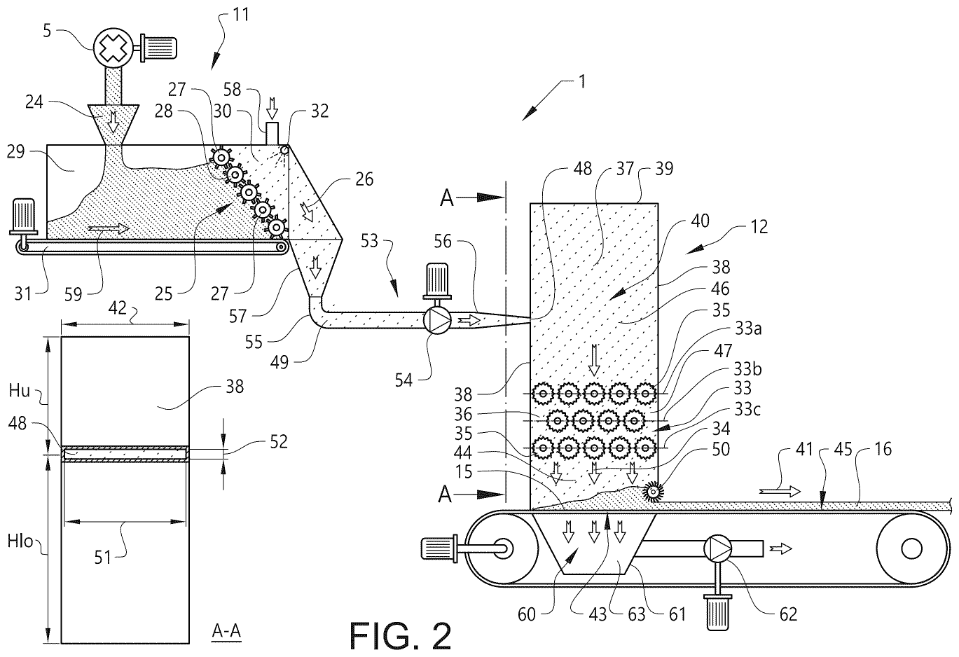

The machine 1 also comprises a preparation tank 11 and a formation tank 12. The function and design of the preparation tank 11 and the formation tank 12 will be further described hereinbelow with reference to FIG. 2.

As shown in FIG. 1, the preparation tank 11 receives the milled material from the milling unit 5, which milled material is dry and fluffy. The milled material is suitably transported from the milling unit 5 to the preparation tank 11 in a conduit 13 by a fan 14. The fan 14 can be arranged to transport the milled material from the milling unit 5 to the preparation tank 11 only, or, as appears from FIG. 1, also be used for returning superfluous material occurring later in the process. In the preparation tank 11, the milled material is disintegrated into particles for further transport to the formation tank 12.

The formation tank 12 is arranged above a movable air permeable belt 15 of the machine 1 to continuously deposit milled material on the belt 15 when the belt is moving. In this way a mat 16 of milled material is formed on the belt 15.

Optionally, the machine 1 also comprises a schematically illustrated cleaning unit 5a for removing contaminants, such as stones, gravel, paper clips, plastic tape or any other contaminant, from the recycled material. Such a cleaning unit is suitably positioned before the preparation tank 11 such that the milled material entering the formation tank 12 is cleaned. For example, the cleaning unit can be arranged between the milling unit 5 and the preparation tank 11. Alternatively, the cleaning unit can be arranged between the preparation tank 11 and the formation tank 12. The cleaning unit 5a may comprise suitable standard equipment for cleaning the type of fibrous material to be treated, such as a sifter, a cyclone, a magnetic separator, etc.

Further, the machine is provided with a compressing unit 17. The mat 16 formed on the belt 15 at the formation tank 12 is fed to the compressing unit 17 which compresses the mat 16 to form the sheet 18.

The compressing unit 17 can comprise a pre-press 19 and a final press 20 for reducing the thickness of the mat 16 in two main steps. The pre-press 19 may have belts and/or rollers to form a partly compressed mat. The final press 20 can be a heat press further compressing the partly compressed mat to form the sheet 18. The heat press suitably has an upper press belt 21 and a lower press belt 22 for forming the sheet 18 therebetween when the mat 16 is passing the compressing unit 17. The heat press suitably operates at a temperature in the range 110-240° C. and provides a pressure in the range 10-75 bar to form the sheet. Alternatively, other types of heat press can also be used.

The thickness of the mat 16 can be reduced from 5 -15 cm to 0.5-3 cm by the pre-press 19 and further compressed by the final press 20 to form the sheet 18 having a thickness in the range 0.5-5 mm, preferably 0.75-3 mm.

In the example embodiment illustrated in FIG. 1, the machine 1 comprises nozzles 23 for adding water to the mat 16 by spraying water droplets onto the mat to increase the heat conductivity of the mat 16 and thereby improve the adhesion between the fibres in the sheet 18. Such nozzles 23 are suitably arranged at the compressing unit 17, preferably between the pre-press 19 and the final press 20. Water can be added on the upper side and/or the underside of the mat 16 before the mat is entering the final press 20.

FIG. 2 is a view of a part of the sheet manufacturing machine 1 illustrated in FIG. 1, and shows the preparation tank 11 and the formation tank 12.

The preparation tank 11 receiving the milled material 24 from the milling unit 5 has a first set of agitators 25 pre-dispersing the milled material in a first air flow 26 inside the preparation tank 11. The first set of agitators suitably comprises a plurality of mechanical agitators, preferably a plurality of rotating rollers 27 provided with protrusions on their respective surfaces. In the example embodiment illustrated in FIG. 2, the plurality of rotating rollers 27 with protrusions, such as doffing rollers, are arranged in a row in the preparation tank 11. The number and size of the rollers can be varied. The number of rollers 27 can be in the range 2-10. The rollers 27 are driven by one or more motors (not shown) for rotating at a speed in the range 500-5000 rpm. Each roller can be provided with a separate motor, or two or more rollers can be driven by one and the same motor. The rotation speed and direction of rotation of one roller can be different from the rotation speed and direction of rotation of another roller comprised in the first set of agitators.

Further, the first set of agitators 25 suitably forms a separating partition 28 between a receiving section 29 of the preparation tank 11 to which milled material 24 is fed and a pre-dispersion section 30 of the preparation tank 11 in which the milled material is pre-dispersed in the first air flow 26.

The milled material 24 is forced to pass via the separating partition 28 formed by the first set of agitators 25 to be pre-dispersed in the first air flow 26. This is performed by the rotation of the rollers 27 moving the milled material from the receiving section 29 to the pre-dispersion section 30. Due to the rotating rollers 27, any lumps or aggregates in the milled material are disintegrated into particles, and all particles are then thrown into the pre-dispersion section 30 and are pre-dispersed in the first air flow 26. Hence, the first set of agitators 25 are arranged to disintegrate a relatively dense pile of milled material 24 and to pre-disperse it into the first air flow 26.

In addition, the preparation tank 11 suitably has a conveyor 31 transporting the milled material 24 entering the preparation tank 11 in the receiving section 29 towards the first set of agitators 25, the conveyor 31 thereby continuously feeding milled material 24 to the first set of agitators 25 for being disintegrated by the rollers 27 and dispersed in the first air flow 26. The feeding direction is indicated with an arrow 59 in FIG. 2.

The machine 1 can also have one or more nozzles 32 for adding a binder and/or water or any other additive to the milled material, and such nozzles 32 are preferably arranged in the preparation tank 11 for injecting, such as spraying, the binder and/or water into the preparation tank 11.

The binder and/or water is preferably added to the milled material by injecting the binder and/or water into the first air flow 26 containing the pre-dispersed milled material. This can be performed in the pre-dispersion section 30 of the preparation tank 11.

The formation tank 12 has a second set of agitators 33 dispersing the pre-dispersed milled material in a second air flow 34 inside the formation tank 12. The second set of agitators suitably comprises a plurality of mechanical agitators, preferably a plurality of rotating rollers 35 provided with protrusions on their respective surfaces. In the example embodiment illustrated in FIG. 2, the plurality of rotating rollers with protrusions, such as spiked rollers, are arranged in a lower part 36 of the formation tank 12. The number and size of the rollers can be varied. The number of rollers 35 can be in the range 5-30. The rollers 35 are driven by one or more motors (not shown) for rotating at a speed in the range 500-5000 rpm. Each roller can be provided with a separate motor, or two or more rollers can be driven by one and the same motor. The rotation speed and direction of rotation of one roller can be different from the rotation speed and direction of rotation of another roller comprised in the second set of agitators 33. Preferably the rollers 35 are divided into at least two floors 33a-c of rollers 35 arranged vertically above each other, each such floor 33 a-c containing, typically, 3-10 rollers.

Hence, the second set of agitators 33 are arranged to further disperse the already pre-dispersed milled material of the first air flow 26 and to form a further dispersed milled material carried along in the second air flow 34.

The formation tank 12 can have four substantially vertical side walls 37, 38 and a top wall 39 forming a chamber 40 above the belt 15. The formation tank 12 may have a rectangular or a square cross section formed by the side walls 37, 38. In a horizontal direction perpendicular to a feeding direction 41 of the belt 15 (and the mat 16), the extension 42 of such a side wall 38 is preferably approximately the same as the width of the belt 15, see cross section A-A. The formation tank 12 is suitably arranged close to, in the immediate vicinity to, and above the belt 15 and has an opening 43 in a bottom portion which opening 43 connects the formation tank 12 to an upper side 45 of the belt 15 and which opening 43 is adapted to the desired width of the mat 16 to be formed on the belt 15. The bottom portion opening 43 overlapping with the belt 15 enables the dispersed milled material 44 to be deposited on the upper side 45 of the belt 15 to form the mat 16 of the milled material when the belt 15 is moving through the zone where the formation tank 12 is situated.

The chamber 40 of the formation tank 12 is suitably divided into an upper space 46 and a lower space 47 where the upper space 46 is substantially free of internal structures and the lower space 47 accommodates the second set of agitators 33. The height and volume of the upper space 46 are suitably within 30-250% of the height and volume, respectively, of the lower space 47. The height Hu of the upper space 46 may be in the range of 0.5-3 meters. The height Hlo of the lower space 47 may be in the range of 0.75-3 meters.

The upper space 46 is preferably arranged above an inlet 48 of the formation tank 12 via which inlet 48 the first air flow 26 containing the pre-dispersed milled material 49 enters the formation tank 12, and the lower space 47 is preferably arranged below the inlet 48 and closer to the belt 15.

In the formation tank 12 or in the immediate vicinity to the formation tank 12, a rotating brush 50 can be arranged above the belt 15 at a location where the mat 16 of the milled material formed on the belt 15 leaves the formation tank 12. Such a brush 50 is arranged for adjusting an initial thickness of the mat 16. The brush 50 is arranged to rotate in the opposite direction to the movement direction 41 of the belt 15 such that excess milled material is pushed back and maintained inside the formation tank 12. As the machine 1 is illustrated in FIG. 2, the movement direction 41 of the upper part of the belt is from left to right and thus, the brush 50 is arranged to rotate clockwise. At the same time, the rotating brush 50 is preferably arranged to seal an interior of the formation tank 12 against ambient air, the pressure drop over the rotating brush 50 being such that ambient air is hindered, at least partly, from leaking into the formation tank 12.

In the example embodiment illustrated in FIG. 2, see cross section A-A, the formation tank 12 has an elongated opening 48, which opening 48 constitutes the inlet mentioned above, arranged in one of said side walls 38. The first air flow 26 containing the pre-dispersed milled material is blown into the formation tank 12 through the elongated opening 48. The elongated opening 48 is suitably arranged with a major extent 51 in a horizontal direction and a minor extent 52 in a vertical direction where the major extent 51 is in parallel with the lateral extension of the belt 15. The elongated opening 48 can have a horizontal extension of approximately the same size as the width 42 of the side wall 38 in which the elongated opening 48 is arranged.

Further, the first air flow 26 containing the pre-dispersed milled material 49 is suitably blown into the formation tank 12 in a substantially horizontal direction.

The machine 1 further comprises a duct 53, such as a pipe, connecting the preparation tank 11 and the formation tank 12, and a feeding fan 54. The first air flow 26 containing the pre-dispersed milled material 49 is transported in the duct 53 from the preparation tank 11 to the formation tank 12 by the feeding fan 54. The duct 53 may have a first duct portion 55 connecting the pre-dispersion section 30 of the preparation tank 11 and the feeding fan 54, and a second duct portion 56 connecting the feeding fan 54 and the formation tank 12. In other words, the feeding fan 54 is arranged in the duct 53 between the preparation tank 11 and the formation tank 12.

The first duct portion 55 can include a funnel 57 connected to the pre-dispersion section 30 of the preparation tank 11, which funnel is preferably arranged in the lower part of the preparation tank 11. In an upper part of the preparation tank 11, an air inlet 58 to the pre-dispersion section 30 can be arranged. This air inlet 58 allows ambient air to enter the pre-dispersion section 30 and to be mixed therein with milled material to form the first air flow 26 with pre-dispersed milled material. The first air flow 26 can be obtained by the feeding fan 54 that draws air into the pre-dispersion section 30 of the preparation tank 11 via the air inlet 58.

The second duct portion 56 has a cross section shape and area that gradually adapts from the dimensions of the outlet of the fan 54 to the dimensions of the inlet 48 of the formation tank 12, at the position where the second pipe portion 56 is connected to the formation tank 12. This means that when using the inlet 48 of the formation tank 12 shaped as the elongated opening 48 as mentioned above, which elongated opening 48 may extend over substantially the entire width 42 of the side wall 38, the second duct portion 56 has a cross section that varies from a first cross section shape at the position where the second duct position 56 is connected to the feeding fan 54, to the position where the second duct portion 56 is connected to the formation tank 12. For example, the cross section shape can vary from circular at the outlet of the feeding fan 54 to the shape of the elongated opening 48 at the formation tank 12.

Further, the machine 1 has a vacuum unit 60 conveying the dispersed milled material 44 by the second air flow 34, from the formation tank 12 to the belt 15 while the belt is moving. The second air flow 34 can be obtained by the vacuum unit 60 that draws air from the formation tank 12 and through the air-permeable belt 15. The vacuum unit 60 is arranged below the formation tank 12 and the moving air-permeable belt 15, and creates an air pressure drop over the belt, or over the belt and the milled material deposited on the belt, drawing the second air flow 34 through the belt 15, whereby the air-permeable belt 15 functions as a filter that collects milled material and allows the air to pass through and further into the vacuum unit 60. Hereby, the milled material is deposited on the belt 15 and forms the mat 16 of the milled material on the belt 15. Due to the combined pre-dispersion of the milled material in the first air flow 26 and the further dispersion of the milled material in the second air flow 34, the distribution of material on the belt 15 will be very even across the width of the belt 15, whereby a mat 16 of even thickness and density can be formed.

The vacuum unit 60 can comprise a vacuum container 61 or box arranged below the belt 15, or rather inside the loop of the belt, and one or more vacuum fans 62 connected to the vacuum container 61. The vacuum container 61 forms a chamber 63 which is closed at a lower end and open at an upper end towards the underside of the belt 15. The vacuum fan 62 creates the pressure drop over the belt 15 by evacuating air from the vacuum container 61. The size, shape and position of the vacuum container, are suitably adapted to the lower part of the formation tank 12. The second air flow 34 containing the dispersed milled material 44 can be controlled by the vacuum fan 62 for achieving the desired deposition of milled material on the belt 15.

The term “vacuum unit” 60 and the function thereof means that the pressure drop can be created, i.e. a lower pressure at the underside of the belt 15 than at the upper side of the belt 15, or than at the upper side of the milled material deposited on the belt 15. The magnitudes of the pressures involved are less important, since it is the pressure drop or pressure difference that determines the depositing properties of the machine 1. The pressure on the underside of the belt 15 is suitably lower than the atmospheric pressure. It is to be understood that the present invention is not limited to the embodiments described above and illustrated in the drawings; rather, the skilled person will recognize that many changes and modifications may be made within the scope of the appended claims.

1. A method for manufacturing a sheet of fibrous material, the method comprising:
providing fibrous;
milling the fibrous material to form a milled material;
pre-dispersing the milled material in a first air flow inside a preparation tank using a first set of agitators arranged in the preparation tank;
transporting the first air flow containing the pre-dispersed milled material in a duct from the preparation tank to a formation tank by a feeding fan;
dispersing the pre-dispersed milled material in a second air flow inside the formation tank using a second set of agitators arranged in the formation tank;
conveying the dispersed milled material by the second air flow, from the formation tank to a moving air-permeable belt, by creating a pressure drop over the belt drawing the second air flow through the belt, thereby depositing milled material on the belt and forming a mat of the milled material on the belt; and
compressing the mat to form the sheet.

2. The method according to claim 1, wherein the first set of agitators comprises a plurality of mechanical agitators.

3. The method according to claim 1, wherein the second set of agitators comprises a plurality of rotating rollers provided with protrusions on their respective surfaces.

4. The method according to claim 3, wherein the rollers of the second set of agitators are divided into at least two floors of rollers arranged vertically above each other.

5. The method according to claim 1, further comprising adding a binder and/or water to the milled material.

6. The method according to claim 5, wherein adding the binder and/or water to the milled material occurs in the preparation tank by injecting, the binder and/or water into the preparation tank via one or more injection nozzles.

7. The method according to claim 5, wherein adding the binder and/or water to the milled material comprises injecting the binder and/or water into the first air flow containing the pre-dispersed milled material.

8. The method according to claim 5, further comprising adding the water in an amount of 0.1-20% by weight of the milled material.

9. The method according to claim 1, wherein the formation tank has an upper space and a lower space, the height and volume of the upper space being within 30-250% of the height and volume, respectively, of the lower space, the upper space being substantially free of internal structures and the second set of agitators being arranged in the lower space.

10. The method according to claim 9, wherein the upper space is arranged above an inlet via which the first air flow containing the pre-dispersed milled material enters the formation tank, and the lower space is arranged below the inlet.

11. The method according to claim 1, further comprising adjusting an initial thickness of the mat by a rotating brush arranged above the belt at a location where the mat of the milled material formed on the belt leaves the formation tank.

12. The method according to claim 11, further comprising sealing an interior of the formation tank against ambient air by the rotating brush.

13. The method according to claim 1, further comprising blowing the first air flow containing the pre-dispersed milled material into the formation tank in a substantially horizontal direction.

14. The method according to claim 1, further comprising blowing the first air flow containing the pre-dispersed milled material into the formation tank through an elongated opening of the formation tank, the opening being arranged with a major extent in a horizontal direction and a minor extent in a vertical direction.

15. The method according to claim 14, wherein the elongated opening is arranged in a side wall of the formation tank.

16. The method according to claim 1, wherein the first set of agitators forms a separating partition between a receiving section of the preparation tank to which milled material is fed and a pre-dispersion section of the preparation tank in which the milled material is pre-dispersed in the first air flow, the milled material being forced to pass via the separating partition formed by the first set of agitators to be pre-dispersed in the first air flow.

17. The method according to claim 1, further comprising transporting the milled material entering the preparation tank towards the first set of agitators by a conveyor arranged in the preparation tank.

18. The method according to claim 1, wherein the fibrous material comprises recycled fibrous material.

19. The method according to claim 1, wherein the fibrous material comprises recycled paper material.

20. The method according to claim 1, further comprising adding water to the mat before and/or during the compressing of the mat.

21. The method according to claim 1, further comprising manufacturing the sheet to constitute paper board having a thickness in the range 0.5-3 mm and a surface weight in the range 500-3000 g/m².

22. The method according to claim 1, wherein the milled material has, from entering the preparation tank to leaving the compression step an absolute moisture content less than 30% by weight.

23. The method according to claim 1, further comprising milling the fibrous material such that for at least 50% by weight of the milled material, the fibers of the milled material have a fiber length in the range 0.2-5 mm and/or the milled material has a particle size less than 10 mm.

24. The method according to claim 1, further comprising forming the mat of the milled material on the belt with a thickness in the range of 5 -15 cm.

25. The method according to claim 1, further comprising compressing the mat in a heat press device providing a temperature in the range 110-240° C. and a pressure in the range 10-75 bar to form the sheet.

26. The method according to claim 1, further comprising pre-compressing the mat to a thickness in the range 0.5-3 cm, and further compressing the mat to form the sheet having a thickness in the range 0.5-5 mm.

27. A sheet manufacturing machine, the machine comprising:
a milling unit for milling fibrous material;
a preparation tank having a first set of agitators for pre-dispersing the milled material in a first air flow inside the preparation tank;
a formation tank having a second set of agitators for dispersing the pre-dispersed milled material in a second air flow inside the formation tank:
a duct connecting the preparation tank and the formation tank;
a feeding fan for transporting the first air flow containing the pre-dispersed milled material in the duct from the preparation tank to the formation tank;
a movable air-permeable belt and a vacuum unit for conveying the dispersed milled material by the second air flow from the formation tank to the belt while the belt is moving, by creating a pressure drop over the belt drawing the second air flow through the belt, thereby depositing milled material on the belt and forming a mat of the milled material on the belt; and
a compressing unit for compressing the mat to form the sheet.
